(19) United States
(12) Patent Application Publication
(10) Pub. No.: US 2014/0157372 A1
(43) Pub. Date: Jun. 5, 2014

(54) IMAGE FORMING APPARATUS, WIRELESS COMMUNICATION SYSTEM, CONTROL METHOD, AND COMPUTER-READABLE MEDIUM

(71) Applicant: Naoki Shimizu, Kanagawa (JP)

(72) Inventor: Naoki Shimizu, Kanagawa (JP)

(21) Appl. No.: 14/085,182

(22) Filed: Nov. 20, 2013

(30) Foreign Application Priority Data
Dec. 5, 2012 (JP) 2012-266335

(51) Int. Cl. H04L 29/06

(52) U.S. Cl. CPC H04L 63/08
USPC 726/4

(57) ABSTRACT

The invention is concerning to an image forming apparatus connected to a mobile terminal via a wireless network includes: an authentication unit configured to perform authentication of the mobile terminal using user authentication information and identification information of the mobile terminal that are registered in advance to the image forming apparatus; a requesting unit configured to request to acquire information stored in the mobile terminal; and an acquiring unit configured to acquire the information from the mobile terminal in response to the request by the requesting unit.

### CROSS-REFERENCE TO RELATED APPLICATIONS

The present application claims priority to and incorporates by reference the entire contents of Japanese Patent Application No. 2012-266335 filed in Japan on Dec. 5, 2012.

### BACKGROUND OF THE INVENTION

1. Field of the Invention

The present invention relates to an image forming apparatus, a wireless communication system, a control method, and a computer-readable medium.

2. Description of the Related Art

There are known techniques that allow an image forming apparatus such as a multifunction peripheral (MFP) to import information about a user (user information), e.g., address book information or program information, from external communication equipment and provide the user information to the user or, more specifically, display the user information on a screen or utilize the user information in application software.

Japanese Laid-open Patent Application No. 2004-236212 discloses a technique, with an aim of eliminating time and effort needed for editing address book information or the like held by external equipment for an image forming apparatus, of automatically causing the image forming apparatus and a remote terminal to mirror and update therebetween a content of editing the information.

However, the conventional technique is disadvantageous in that validation, or security check, of user information to be imported is not performed. This disadvantage matters considerably greatly in a situation where the user information is imported from a mobile terminal held by an individual user, rather than from a stationary-installed information-management-type server, which is typified by a Lightweight Directory Access Protocol (LDAP) server, having conventionally been frequently used.

In particular, an MFP can acquire address book information from a communication terminal on a network and display the address book information or use the information as a destination address. However, security between the MFP and the communication terminal is disregarded. More specifically, consideration is given neither to authentication between a user terminal and an MFP using user login or the like nor to authentication between a mobile terminal and an MFP using a mobile terminal identifier such as MAC address.

Japanese Laid-open Patent Application No. 2004-236212 discloses a technique of mirroring information between an image forming apparatus and a remote terminal. However, despite that it is necessary to validate each mobile terminal from a security viewpoint in a situation where information is mirrored from a particularly large number of terminals such as mobile terminals, no consideration is given to this regard in Japanese Laid-open Patent Application No. 2004-236212.

Under the circumstance, there is needed to provides an image forming apparatus that is capable of importing user information and, furthermore, performing authentication of a communication terminal, which is an information source, typified by a mobile terminal when importing the user information.

It is an object of the present invention to at least solve the problems in the conventional technology.

### SUMMARY OF THE INVENTION

It is an object of the present invention to at least partially solve the problems in the conventional technology.

According to the present invention, there is provided: an image forming apparatus connected to a mobile terminal via a wireless network, the image forming apparatus comprising: an authentication unit configured to perform authentication of the mobile terminal using user authentication information and identification information of the mobile terminal that are registered in advance to the image forming apparatus; a requesting unit configured to request to acquire information stored in the mobile terminal; and an acquiring unit configured to acquire the information from the mobile terminal in response to the request by the requesting unit.

The present invention also provides a wireless communication system in which an image forming apparatus and a mobile terminal are connected to each other via a wireless network, the wireless communication system comprising: an authentication unit configured to perform authentication of the mobile terminal using user authentication information and identification information of the mobile terminal that are registered in advance to the image forming apparatus; a requesting unit configured to request to acquire information stored in the mobile terminal; and an acquiring unit configured to acquire the information from the mobile terminal in response to the request by the requesting unit.

The present invention also provides a non-transitory computer-readable medium that contains a computer program that, when executed by a computer of an image forming apparatus connected to a mobile terminal via a wireless network, cause the computer to perform operations comprising: performing authentication of the mobile terminal using user authentication information and identification information of the mobile terminal that are registered in advance to the image forming apparatus; requesting to acquire information stored in the mobile terminal; and acquiring the information from the mobile terminal in response to the requesting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of a wireless communication system according to a first embodiment of the present invention;

FIG. 2 is an explanatory diagram of a sequence of processes in a preparatory stage of the wireless communication system according to the first embodiment;

FIG. 3 is an explanatory diagram of a sequence of processes in an execution stage of the wireless communication system according to the first embodiment;

FIG. 4 is a block diagram illustrating a schematic configuration of a wireless communication system according to a second embodiment of the present invention;

FIG. 5 is an explanatory diagram of a preparatory stage sequence of the wireless communication system according to the second embodiment;

FIG. 6 is an explanatory diagram of an execution stage sequence of the wireless communication system according to the second embodiment;

FIG. 7 is a block diagram illustrating a schematic configuration of a wireless communication system according to a third embodiment of the present invention;

FIG. 8 is an explanatory diagram of a preparatory stage sequence of the wireless communication system according to the third embodiment;

FIG. 9 is an explanatory diagram of an execution stage sequence of the wireless communication system according to the third embodiment;

FIG. 10 is an explanatory diagram of an execution stage sequence of the wireless communication system according to a fourth embodiment;

FIG. 11 is an explanatory diagram of an execution stage sequence of the wireless communication system according to a fifth embodiment;

FIG. 12 is an explanatory diagram of an execution stage sequence of the wireless communication system according to a sixth embodiment; and

FIG. 13 is an explanatory diagram of an execution stage sequence of the wireless communication system according to a seventh embodiment.

### DETAILED DESCRIPTION OF THE PREFERRED EMBODIMENTS

Exemplary embodiments of the invention are described in detail below with reference to the accompanying drawings. In the drawings, like reference numerals designate identical or corresponding parts throughout several diagrams, and description thereof is simplified or omitted as appropriate.

According to an embodiment of the present invention, an image forming apparatus not only imports user information from a communication terminal, which is an information source, typified by a mobile terminal, but also performs authentication of the communication terminal. Utilizing a user authentication function that is generally provided in an image forming apparatus is convenient to validate the information source. To utilize this function, a user authenticated via user authentication is associated with a mobile terminal belonging to the user.

It is assumed that each embodiment is applied to an image forming apparatus used in a characteristic environment. Examples of such an environment is that the image forming apparatus is installed in a convenience store and used by a large number of unspecified users.

More specifically, although there is a demand for utilizing user information such as address book information or program information that resides in a mobile terminal in application software (hereinafter, “application”) of the image forming apparatus, the user information is not held or managed in the image forming apparatus.

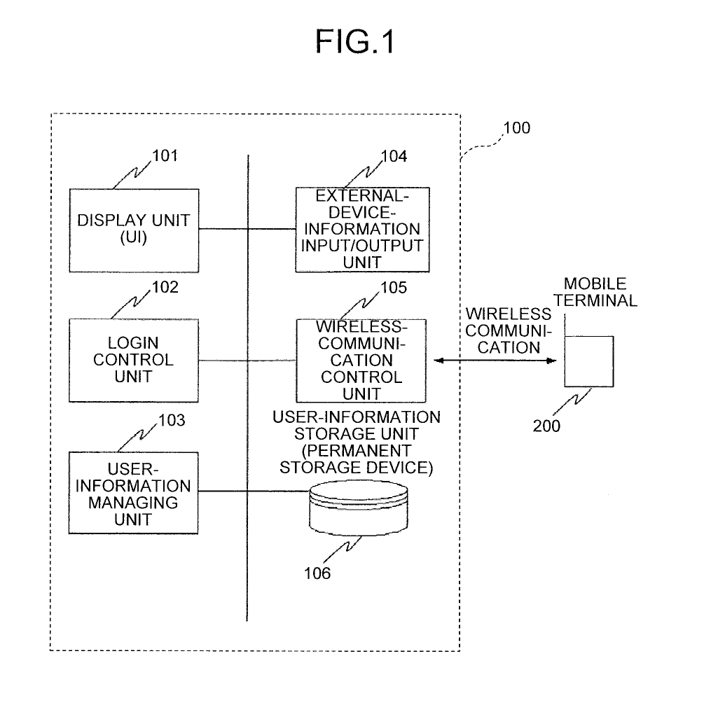

Features of the present invention described above are described in detail below with reference to the accompanying drawings. A wireless communication system according to a first embodiment of the present invention is described first. FIG. 1 is a block diagram illustrating a schematic configuration of the wireless communication system according to the first embodiment.

Referring to FIG. 1, the wireless communication system includes an image forming apparatus 100 and a mobile terminal 200. The image forming apparatus 100 and the mobile terminal 200 are connected to each other via a wireless network. The image forming apparatus 100 includes a display unit (user interface (UI)) 101, a login control unit 102, a user-information managing unit 103, an external-device-information input/output unit 104, a user-information storage unit 106 which is a permanent storage device, and a wireless-communication control unit 105.

The display unit (UI) 101, which is a user interface, provides on-screen display and is used by a user in inputting information. The login control unit 102 performs control related to login authentication and controls functions performed at login. The user-information managing unit 103 manages a user ID(s), login authentication information, address book information, identification information of a mobile terminal(s), and the like, each of which is information associated with a user account.

The user-information storage unit 106, which is a permanent storage device, is a storage device such as a hard disk drive (HDD) or a solid state drive (SSD) and refers to an area where the user information described above is to be stored. The external-device-information input/output unit 104 controls input and output of information to and from external devices such as the mobile terminal 200 and a contactless medium, e.g., an IC card. The wireless-communication control unit 105 controls communications with a wireless terminal(s) such as the mobile terminal 200.

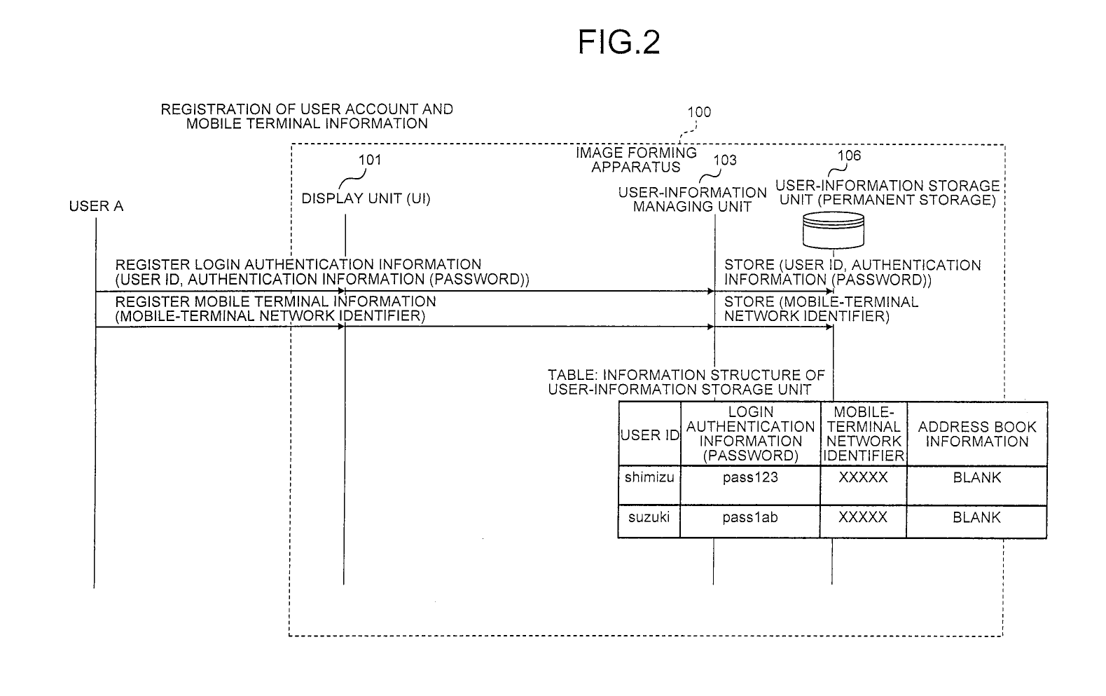

A sequence of processes in a preparatory stage (hereinafter, “preparatory stage sequence”) including registering a user account and mobile terminal information is described below with reference to FIG. 2. FIG. 2 is an explanatory diagram of the preparatory stage sequence of the wireless communication system according to the first embodiment.

In the sequence shown in FIG. 2, a user A creates a user account in the image forming apparatus 100 as the preparatory stage for registration of the user account. As the user account, a password necessary for manual authentication and an identifier of the mobile terminal 200 to be used by the user A are registered. This identifier includes a network identifier, such as a MAC address, necessary for the image forming apparatus 100 to establish a communication session with the mobile terminal 200 via the network.

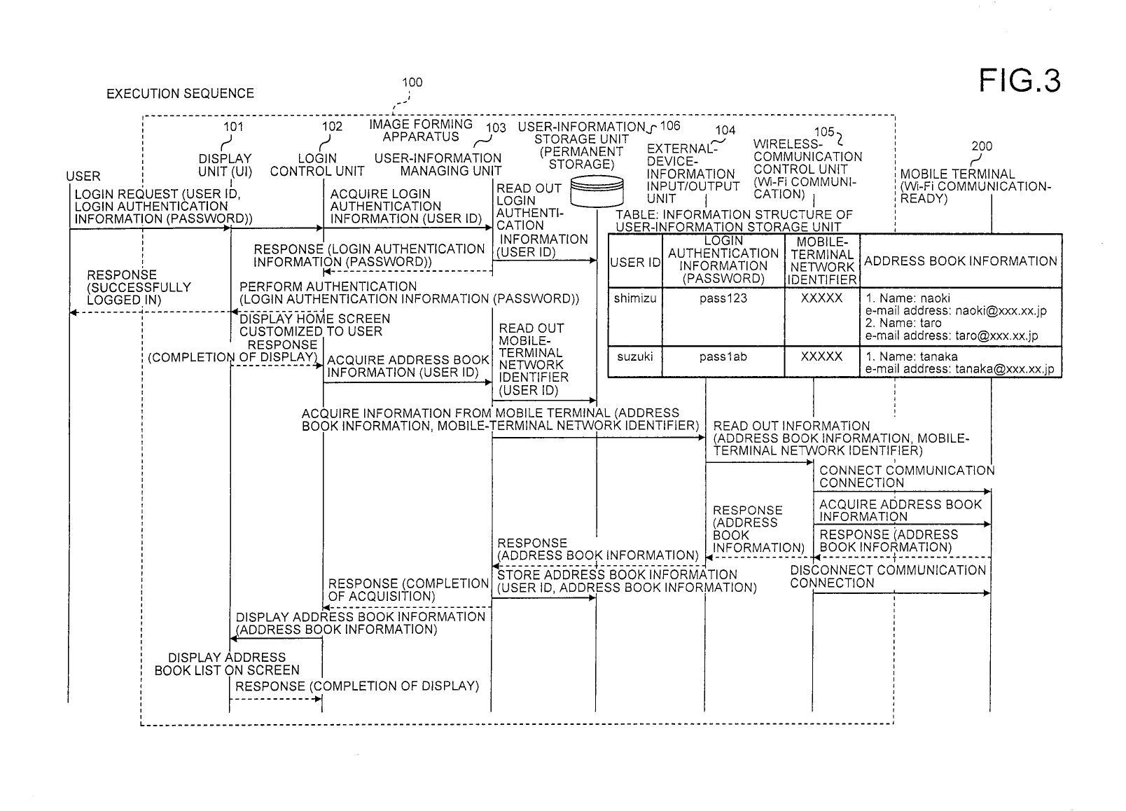

A sequence of processes in an execution stage (hereinafter, “execution stage sequence”) where the user information is imported is described below with reference to FIG. 3. FIG. 3 is an explanatory diagram of the execution stage sequence of the wireless communication system according to the first embodiment.

In the sequence shown in FIG. 3, a user makes a login request to the image forming apparatus 100. The login request is made by manually entering a user ID and a password from the display unit 101 of the image forming apparatus 100.

When the login is successfully authenticated, the image forming apparatus 100 reads out a “mobile-terminal network identifier” from a user information table of the user stored in the user-information storage unit 106. A communication session with the mobile terminal 200 is established using the network identifier as a key. A Wireless Fidelity (Wi-Fi) communication protocol or the like can be used as a communication protocol.

The image forming apparatus 100 acquires address book information from the mobile terminal 200 in the established communication session and stores the address book information in the user-information storage unit 106. The stored address book information is displayed on a screen of the display unit 101 of the image forming apparatus 100.

Structures of data used in the sequences of the wireless communication system are described below. The user ID is key information for uniquely identifying the user in the image forming apparatus 100. The same ID is also used as a user ID for login authentication. The login authentication information is authentication information, such as the password, necessary for the user to log in the image forming apparatus 100.

The “mobile-terminal network identifier” is identification information to be used by the image forming apparatus 100 in carrying out communications such as Wi-Fi communications with the mobile terminal 200 via the network. More specifically, the “mobile-terminal network identifier” is address information of the mobile terminal 200 on the network or the like. The address book information is address book information containing an e-mail destination address of the user and the like.

As described above, according to the first embodiment, address book information that resides in a mobile terminal is mirrored to an image forming apparatus when a user logs in the image forming apparatus. Therefore, the user can use the address book information of the mobile terminal on the image forming apparatus without performing a cumbersome procedure. Accordingly, the user can utilize the address book information as a destination address in e-mail transmission or facsimile transmission.

Furthermore, because mirroring of the address book information is performed on a precondition that the user has logged in, unauthorized access to a mobile terminal can be eliminated, and security of information to be handled by the image forming apparatus can be ensured. These advantages are expected to be highly effective in a situation where, for example, a user uses an MFP that does not contain address book information, and is installed in a convenience store or the like.

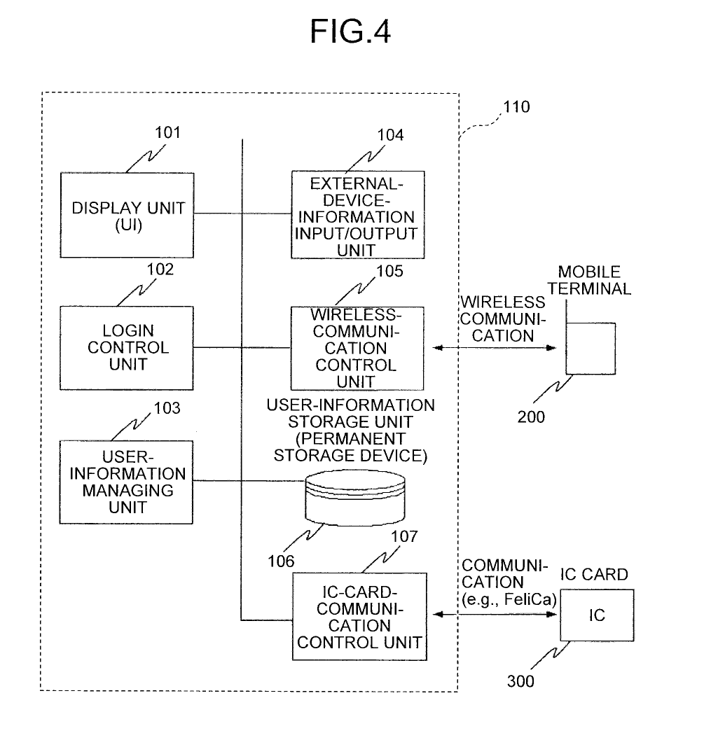

A wireless communication system according to a second embodiment of the present invention is described below. FIG. 4 is a block diagram illustrating a schematic configuration of the wireless communication system according to the second embodiment. The second embodiment differs from the first embodiment illustrated in FIG. 1 in additionally including an integrated circuit (IC) card 300 and an IC-card-communication control unit 107.

The IC-card-communication control unit 107 controls communications with the contactless IC card 300. More specifically, the IC-card-communication control unit 107 controls data input/output including an authentication function. The external-device-information input/output unit 104 controls input and output of information to and from external devices such as the mobile terminal 200 and a contactless medium, e.g., the IC card 300.

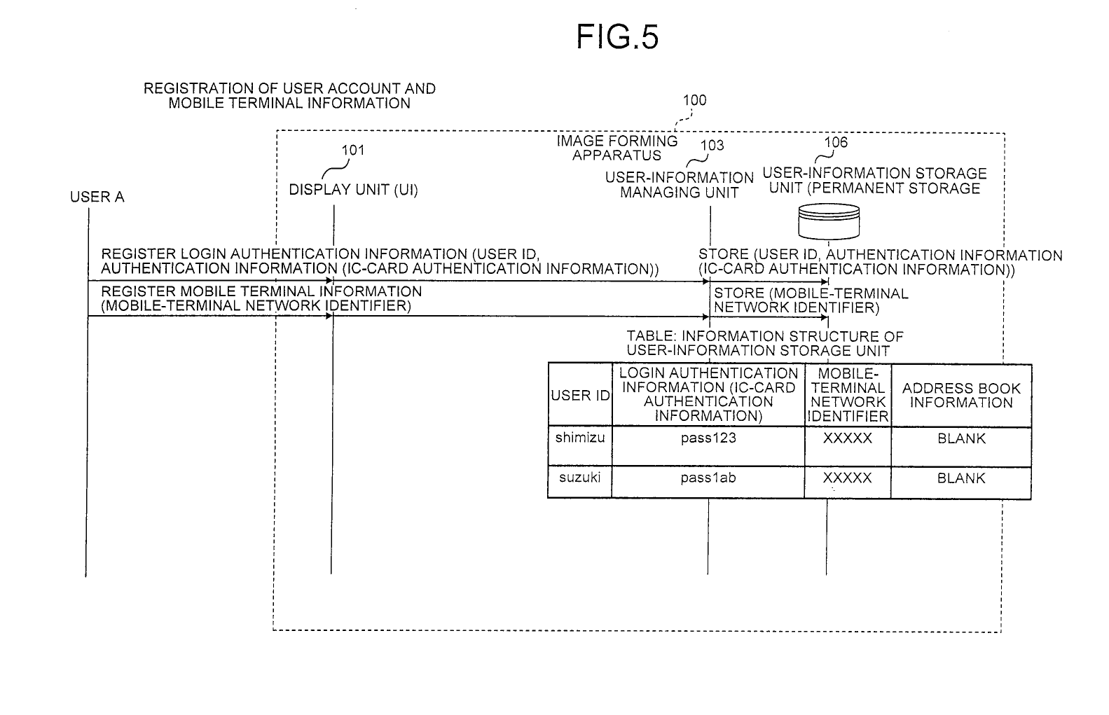

A preparatory stage sequence including registering a user account and mobile terminal information is described below with reference to FIG. 5. FIG. 5 is an explanatory diagram of the preparatory stage sequence of the wireless communication system according to the second embodiment.

In the sequence shown in FIG. 5, the user A creates a user account in an image forming apparatus 110 as a preparatory stage for registration of the user account. As the user account, authentication information to be verified in login authentication of the IC card 300 and an identifier of the mobile terminal 200 to be used by the user A are registered. This identifier includes a network identifier, such as a MAC address, necessary for the image forming apparatus 110 to establish a communication session with the mobile terminal 200 via the network.

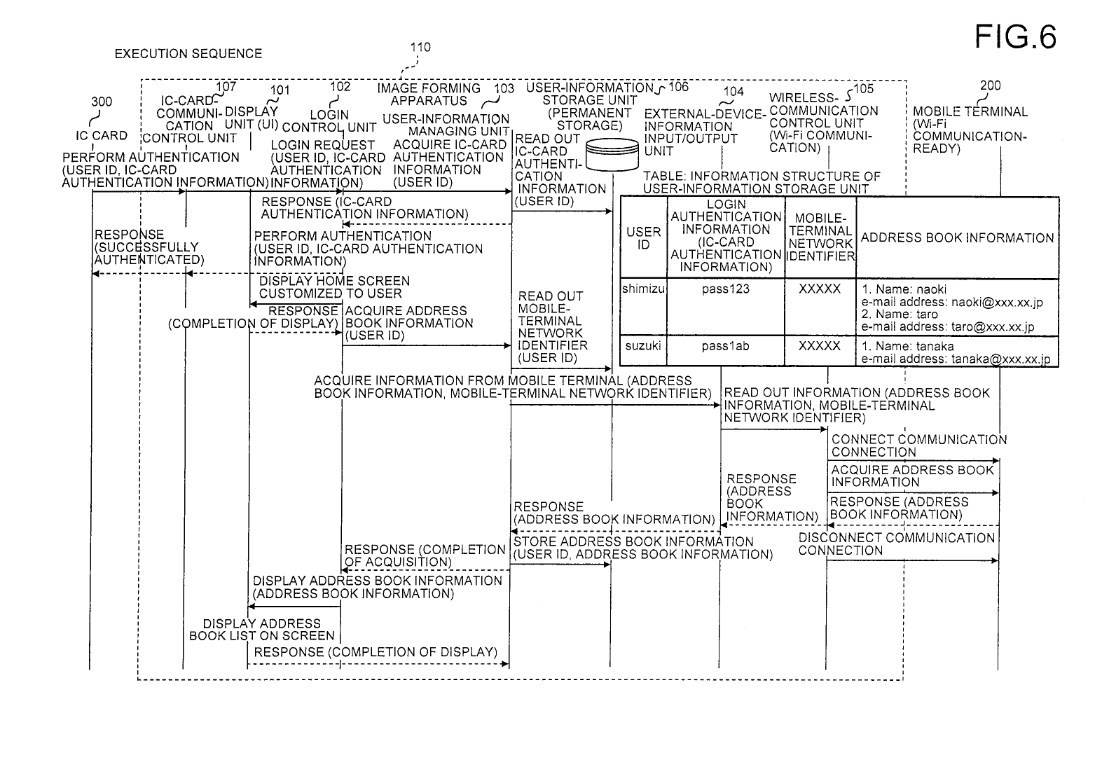

An execution stage sequence where user information is imported is described below with reference to FIG. 6. FIG. 6 is an explanatory diagram of the execution stage sequence of the wireless communication system according to the second embodiment.

In the sequence shown in FIG. 6, a user makes a login attempt by bringing the IC card 300 to proximity of the IC-card-communication control unit 107, which is an IC card reader of the image forming apparatus 110. The image forming apparatus 110 performs authentication by acquiring corresponding login authentication information from the user-information storage unit 106 using a user ID detected by the IC-card-communication control unit 107 as a key.

When the login is successfully authenticated, the image forming apparatus 110 reads out a “mobile-terminal network identifier” from a user information table of the user stored in the user-information storage unit 106. A communication session with the mobile terminal 200 is established by using the network identifier as a key. A Wi-Fi communication protocol or the like can be used as a communication protocol.

The image forming apparatus 110 acquires address book information from the mobile terminal 200 in the established communication session and stores the information in the user-information storage unit 106. The stored address book information is displayed on the screen of the display unit 101 of the image forming apparatus 110.

A structure of data used in the sequences of the wireless communication system is described below. The login authentication information is authentication information necessary for the user when logging in the image forming apparatus 110 or, more specifically, authentication information that resides in the IC card 300.

In the first embodiment, a user needs to manually enter an ID and a password to log in. By contrast, the second embodiment can facilitate an authentication procedure to be carried out by a user by performing authentication using a contactless communication medium such as an IC card.

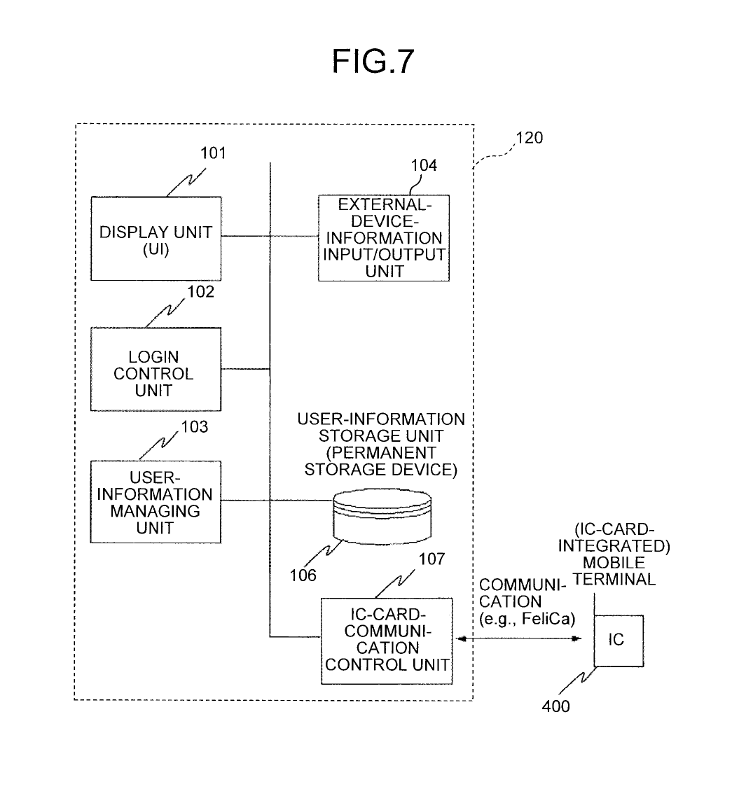

Next, a wireless communication system according to a third embodiment of the present invention is described below. FIG. 7 is a block diagram illustrating a schematic configuration of the wireless communication system according to the third embodiment. The third embodiment differs from the first embodiment illustrated in FIG. 1 in including the IC-card-communication control unit 107 in lieu of the wireless-communication control unit 105 and including an IC-card-integrated mobile terminal 400 in lieu of the mobile terminal 200.

The IC-card-communication control unit 107 controls communications with the contactless-IC-card-integrated mobile terminal 400. More specifically, the IC-card-communication control unit 107 controls data input/output including an authentication function.

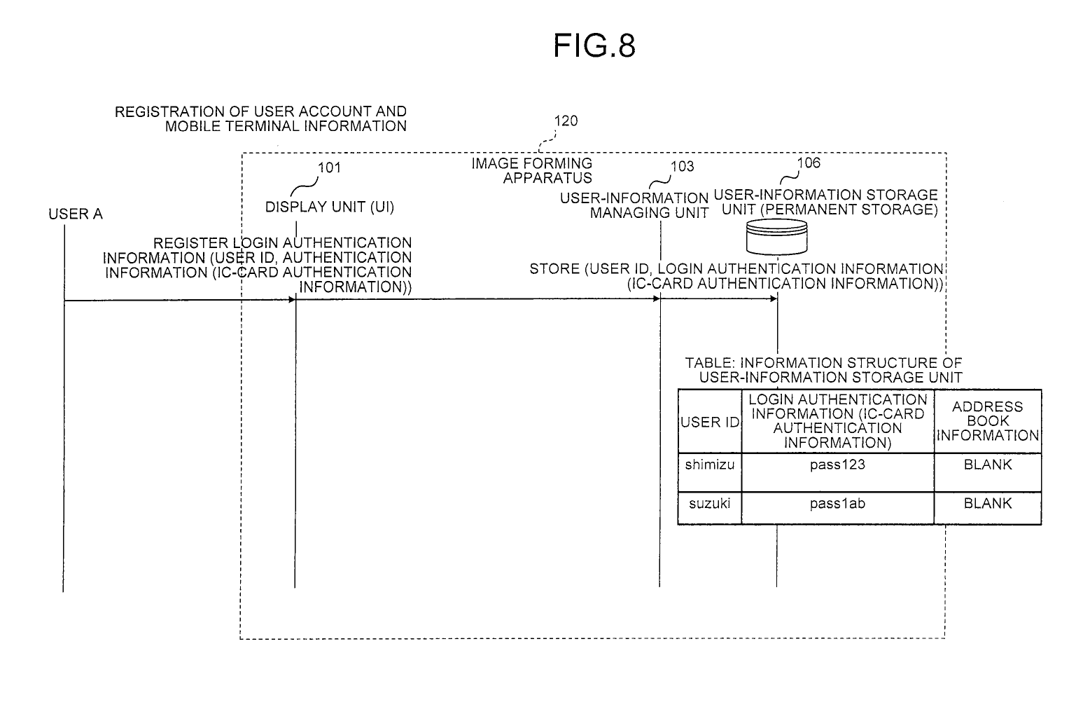

A preparatory stage sequence including registering a user account and mobile terminal information is described below with reference to FIG. 8. FIG. 8 is an explanatory diagram of the preparatory stage sequence of the wireless communication system according to the third embodiment.

In the sequence shown in FIG. 8, the user A creates a user account in an image forming apparatus 120 as the preparatory stage for registration of the user account. As the user account, authentication information to be verified in login authentication of an IC device such as a contactless IC card, which is a contactless medium typified by FeliCa (registered trademark), is registered.

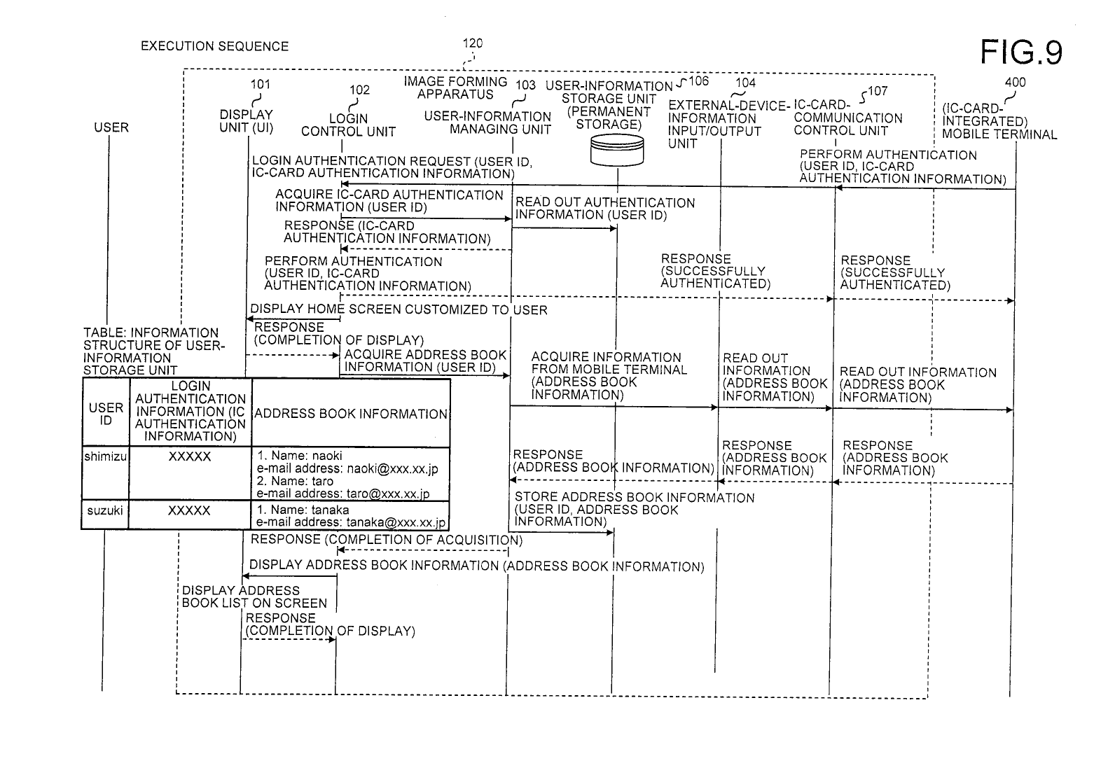

An execution stage sequence where user information is imported is described below with reference to FIG. 9. FIG. 9 is an explanatory diagram of the execution stage sequence of the wireless communication system according to the third embodiment.

In the sequence shown in FIG. 9, a user makes a login attempt by bringing the mobile terminal 400 having a near field communication function such as a FeliCa to proximity of the IC-card-communication control unit 107, which is an IC card reader of the image forming apparatus 120. The image forming apparatus 120 performs authentication by acquiring corresponding login authentication information from the user-information storage unit 106 using a user ID detected by the IC-card-communication control unit 107 as a key.

When the login is successfully authenticated, the image forming apparatus 120 acquires address book information from the IC-card-integrated mobile terminal 400 in the same wireless communication, in which the user authentication is performed, and stores the information in the user-information storage unit 106. The stored address book information is displayed on the screen of the display unit 101 of the image forming apparatus 120.

A structure of data used in the sequences of the wireless communication system is described below. The login authentication information is authentication information necessary for the user when logging in the image forming apparatus 120. As the login authentication information, the authentication information that resides in the IC-card-integrated mobile terminal 400 is registered.

According to the third embodiment, user authentication and acquisition of address book information from a mobile terminal can be performed by a single procedure; this is attained by utilizing a contactless communication unit, such as a FeliCa, integrated in the mobile terminal. Furthermore, the need of a preliminary operation, which needs to be performed according to the first and second embodiments, of registering a communication identifier of the mobile terminal is eliminated. Because a majority of recent mobile terminals is equipped with a contactless communication unit, such as a FeliCa, the third embodiment is applicable to a large number of types of mobile terminals.

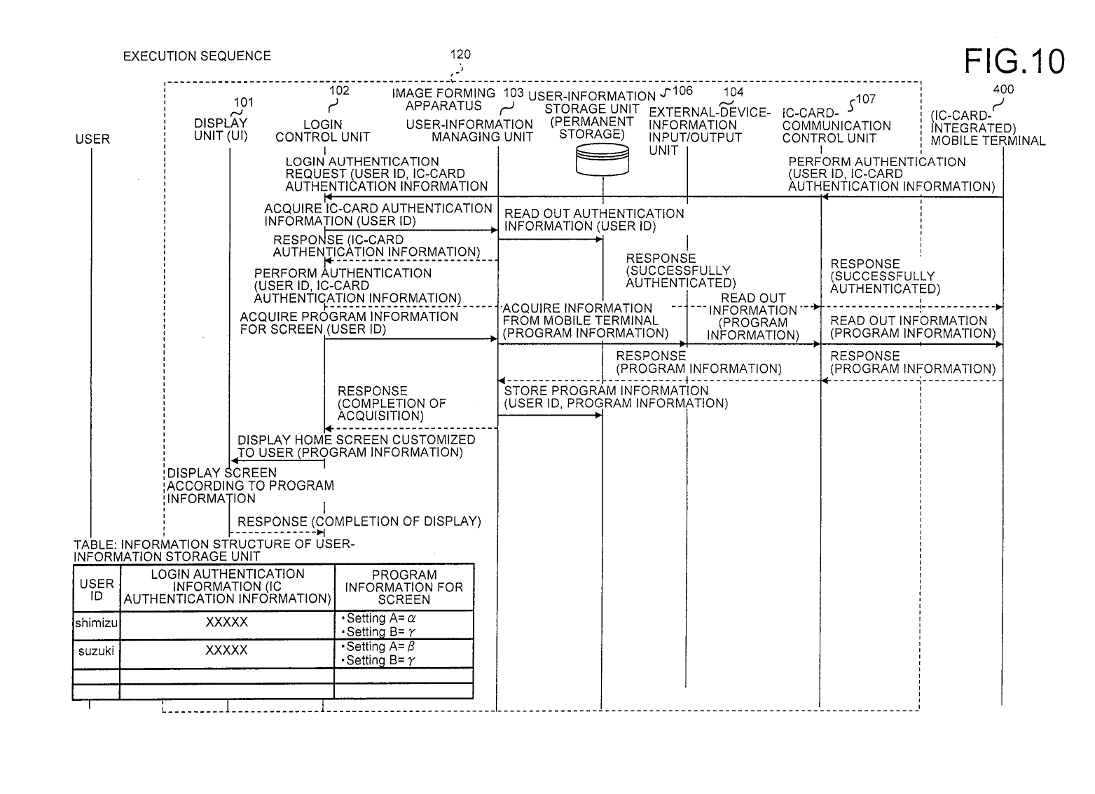

An execution stage sequence where user information is imported is described below with reference to FIG. 10. FIG. 10 is an explanatory diagram of the execution stage sequence of the wireless communication system according to a fourth embodiment of the present invention. Schematic configuration of the wireless communication system, structures of data used in the sequence of the wireless communication system, and a preparatory stage sequence including registering a user account and mobile terminal information of the fourth embodiment are similar to those of the third embodiment.

In the sequence shown in FIG. 10, a user makes a login attempt by bringing the mobile terminal 400 having the near field communication function, such as a FeliCa, to proximity of the IC-card-communication control unit 107, which the IC card reader of the image forming apparatus 120. The image forming apparatus 120 performs authentication by acquiring corresponding login authentication information from the user-information storage unit 106 using a user ID detected by the IC-card-communication control unit 107 as a key.

When the login is successfully authenticated, the image forming apparatus 120 acquires program information from the IC-card-integrated mobile terminal 400 in the same wireless communication, in which the user authentication is performed, and stores the information in the user-information storage unit 106. An on-screen display is provided on the display unit 101 of the image forming apparatus 120 according to the stored program information.

The structures of data used in the sequence of the wireless communication system are similar to those of the third embodiment, and repeated description is omitted.

In the fourth embodiment, information to be acquired is not address book information but program information, such as an on-screen display condition customized to a user.

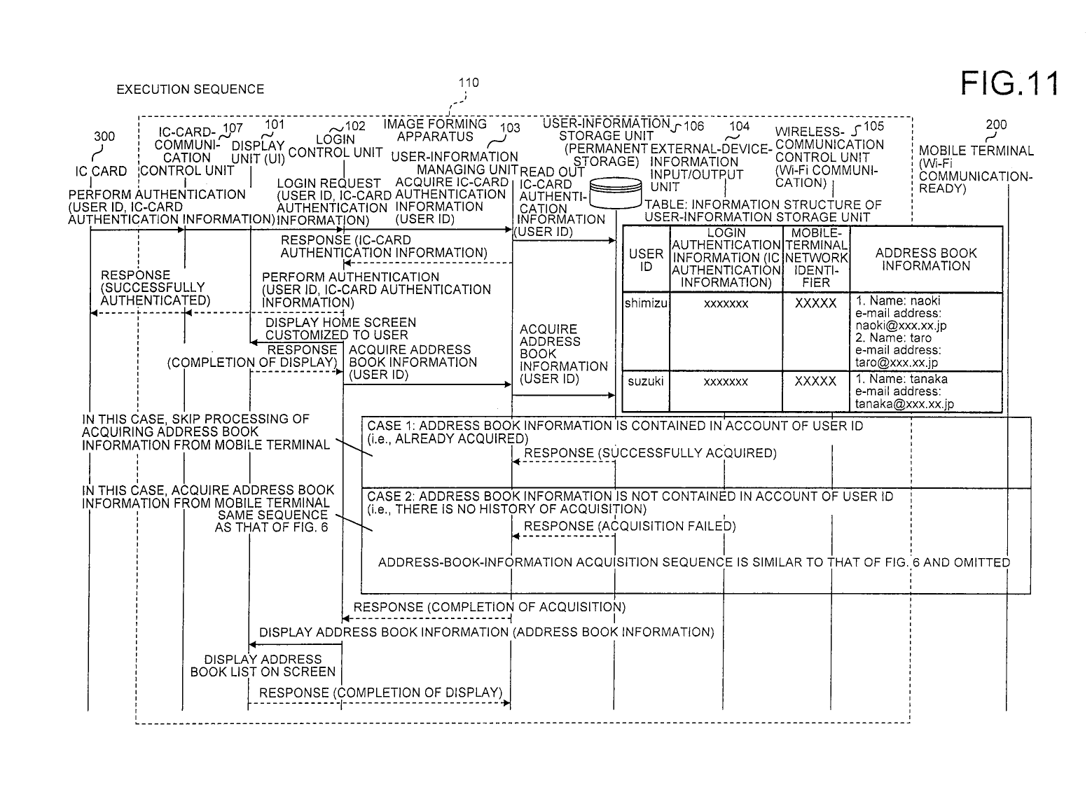

An execution stage sequence where user information is imported is described below with reference to FIG. 11. FIG. 11 is an explanatory diagram of the execution stage sequence of the wireless communication system according to a fifth embodiment of the present invention. Schematic configuration of the wireless communication system, structures of data used in the sequence of the wireless communication system, and a preparatory stage sequence including registering a user account and mobile terminal information of the fifth embodiment are similar to those of the second embodiment.

In the sequence shown in FIG. 11, a user makes a login attempt by bringing the IC card 300 to proximity of the IC-card-communication control unit 107, which is the IC card reader of the image forming apparatus 110. The image forming apparatus 110 performs authentication by acquiring corresponding login authentication information from the user-information storage unit 106 using a user ID detected by the IC-card-communication control unit 107 as a key.

When the login is successfully authenticated, the image forming apparatus 110 searches through the user-information storage unit 106 to determine whether or not “address book information” that has ever been acquired by the image forming apparatus 110 is included in user information associated with the user ID. When such address book information is included, the image forming apparatus 110 displays the information on-screen.

When such address book information is not included in the user information, the image forming apparatus 110 reads out a “mobile-terminal network identifier” from a user information table of the user stored in the user-information storage unit 106. A communication session with the mobile terminal 200 is established by using the network identifier as a key. A Wi-Fi communication protocol or the like can be used as a communication protocol.

The image forming apparatus 110 acquires address book information from the mobile terminal 200 in the established communication session and stores the information in the user-information storage unit 106. The stored address book information is displayed on the screen of the display unit 101 of the image forming apparatus 110.

The structures of data used in the sequence of the wireless communication system are similar to those of the second embodiment, and repeated description is omitted.

Address book information and program information such as a screen display condition are not changed frequently. Therefore, it will be unnecessary to import such information from a mobile terminal each time a user logs in as in the first to third embodiments described above.

More specifically, the following configuration can be employed. Information that is ever imported from a mobile terminal is stored in a non-volatile area of an image forming apparatus. By utilizing the information stored in the non-volatile area at later logins, an increase in frequency of communications between the image forming apparatus and the mobile terminal can be reduced. As a result, frequency of occurrence of functional error resulting from a communication error or the like can be reduced.

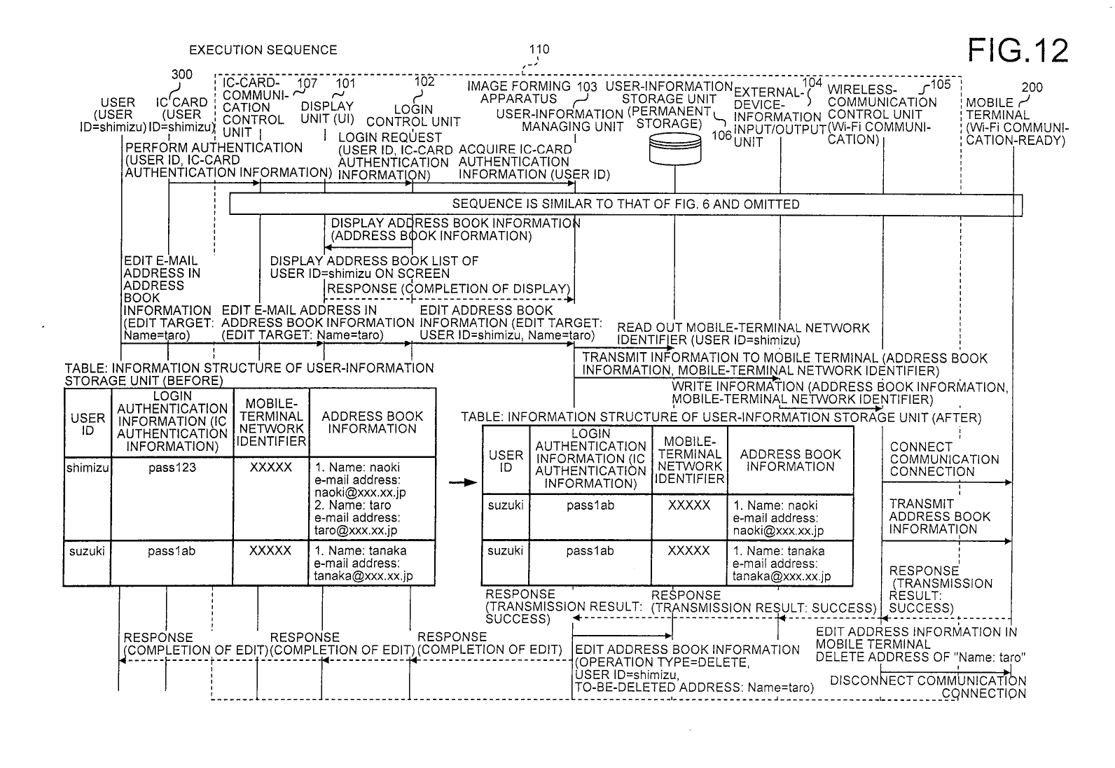

An execution stage sequence where user information is imported is described below with reference to FIG. 12. FIG. 12 is an explanatory diagram of the execution stage sequence of the wireless communication system according to a sixth embodiment of the present invention. Schematic configuration of the wireless communication system, structures of data used in the sequence of the wireless communication system, and a preparatory stage sequence including registering a user account and mobile terminal information of the sixth embodiment are similar to those of the second embodiment.

In the sequence shown in FIG. 12, a user makes a login attempt by bringing an IC card 300 to proximity of the IC-card-communication control unit 107, which is the IC card reader of the image forming apparatus 110. The image forming apparatus 110 performs authentication by acquiring corresponding login authentication information from the user-information storage unit 106 using a user ID detected by the IC-card-communication control unit 107 as a key.

When the login is successfully authenticated, the image forming apparatus 110 reads out a “mobile-terminal network identifier” from a user information table of the user stored in the user-information storage unit 106. A communication session with the mobile terminal 200 is established by using the network identifier as a key. A Wi-Fi communication protocol or the like can be used as a communication protocol.

The image forming apparatus 110 acquires address book information from the mobile terminal 200 in the established communication session and stores the information in the user-information storage unit 106. The stored address book information is displayed on the screen of the display unit 101 of the image forming apparatus 110.

The user then edits the address book information displayed on the screen. In the illustrated example, the user deletes an e-mail address of “Name: taro”. When the address book information has been edited, the image forming apparatus 110 establishes a communication session with the mobile terminal 200 using the Wi-Fi protocol and transmits the address book information to the mobile terminal 200. The mobile terminal 200 performs update to the received address book information.

Structures of data used in the sequence of the wireless communication system are similar to those of the second embodiment, and repeated description is omitted.

There is a demand for not only importing address book information but also editing the address book information displayed on an image forming apparatus. Such a demand can be met by not only importing information between a mobile terminal and an image forming apparatus but also updating to edited information therebetween.

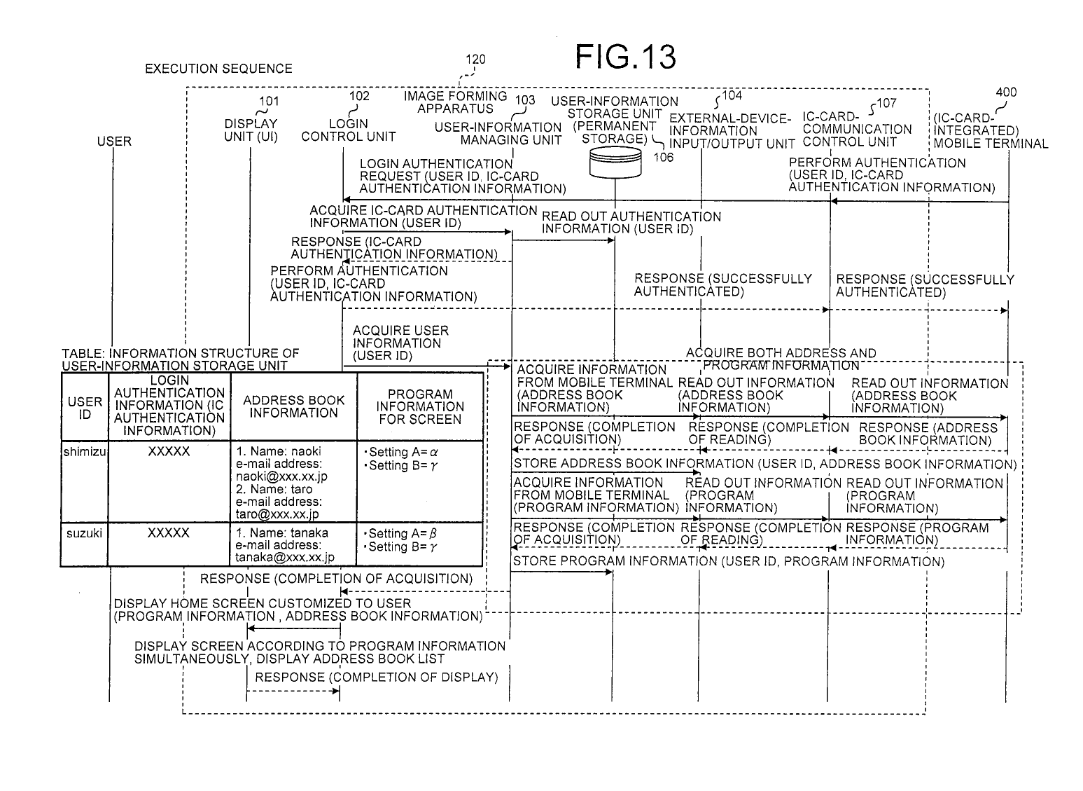

An execution stage sequence where user information is imported is described below with reference to FIG. 13. FIG. 13 is an explanatory diagram of the execution stage sequence of the wireless communication system according to a seventh embodiment of the present invention. Schematic configuration of the wireless communication system, structures of data used in the sequence of the wireless communication system, and a preparatory stage sequence including registering a user account and mobile terminal information of the seventh embodiment are similar to those of the third embodiment.

In the sequence shown in FIG. 13, a user makes a login attempt by bringing the mobile terminal 400 having the near field communication function, such as a FeliCa, to proximity of the IC-card-communication control unit 107, which the IC card reader of the image forming apparatus 120. The image forming apparatus 120 performs authentication by acquiring corresponding login authentication information from the user-information storage unit 106 using a user ID detected by the IC-card-communication control unit 107 as a key.

When the login is successfully authenticated, the image forming apparatus 120 acquires address book information and program information from the IC-card-integrated mobile terminal 400 in the same wireless communication, in which the user authentication is performed, and stores the information in the user-information storage unit 106. An on-screen display is provided on the display unit 101 of the image forming apparatus 120 according to the stored program information, and the address book information is also displayed on-screen.

The structures of data used in the sequence of the wireless communication system are similar to those of the third embodiment, and repeated description is omitted.

In the first to sixth embodiments described above, only a single type of information, which is either address book information or program information, can be mirrored at a user login. However, there is a demand for mirroring a plurality of types of information, e.g., address book information and program information, in some circumstance that depends on a user environment. To meet such a demand, the seventh embodiment is configured to allow mirroring both the address book information and the program information.

According to an aspect of an embodiment of the present invention, there can be obtained an image forming apparatus, a wireless communication system, a control method, and a computer-readable medium capable of ensuring security of information to be handled by the image forming apparatus. This is attained by authenticating a communication terminal, which is an information source, typified by a mobile terminal when the image forming apparatus imports information from the information source.

The present invention is not limited to the embodiments described above. The image forming apparatus according to an aspect of the invention may have a function of authenticating a user and a mobile terminal. The mobile terminal according to an aspect of the invention may have a function of authenticating a user and the mobile terminal. Each of the number of image forming apparatuses and the number of mobile terminals that make up a wireless communication system may be two or more; there is no specific limitation on which one of the image forming apparatuses and the mobile terminals is to have the function. The configuration of the system, in which the image forming apparatus and the mobile terminal are connected to each other, described in the embodiments is only an example and, as a matter of course, there can be various system configuration examples depending on a use and a purpose.

It is possible to cause each sequences in the embodiments illustrated in FIGS. 2, 3, 5, 6, and 8 to 13 to be performed by executing program instructions on a computer. More specifically, a central processing unit (not shown) contained in an image forming apparatus or a mobile terminal loads the program instructions stored in a storage medium such as a read only memory or a random access memory and sequentially executes process steps according to the program instructions.

According to an aspect of an embodiment of the present invention, there can be obtained an image forming apparatus capable of, when importing user information from an information source, authenticating a communication terminal which is the information source typified by a mobile terminal, thereby ensuring security of information handled by the image forming apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus connected to a mobile terminal via a wireless network, the image forming apparatus comprising:
an authentication unit configured to perform authentication of the mobile terminal using user authentication information and identification information of the mobile terminal that are registered in advance to the image forming apparatus;
a requesting unit configured to request to acquire information stored in the mobile terminal; and
an acquiring unit configured to acquire the information from the mobile terminal in response to the request by the requesting unit.

2. The image forming apparatus according to claim 1, wherein the authentication information and the identification information are input via a contactless medium.

3. The image forming apparatus according to claim 2, wherein the mobile terminal includes the contactless medium therein.

4. The image forming apparatus according to claim 1, further comprising
a storage unit configured to store information that have been ever acquired by the image forming apparatus from the mobile terminal, wherein
if, when a new request to acquire information stored in the mobile terminal is issued, the information stored in the mobile terminal specified by the new request is not stored in the storage unit, the image forming apparatus newly acquires the information stored in the mobile terminal.

5. The image forming apparatus according to claim 1, further comprising an editing unit that edits the information stored in the mobile terminal after the information is acquired.

6. The image forming apparatus according to claim 1, wherein the information stored in the mobile terminal includes at least any one of address book information and program information of the mobile terminal.

7. A wireless communication system in which an image forming apparatus and a mobile terminal are connected to each other via a wireless network, the wireless communication system comprising:
an authentication unit configured to perform authentication of the mobile terminal using user authentication information and identification information of the mobile terminal that are registered in advance to the image forming apparatus;
a requesting unit configured to request to acquire information stored in the mobile terminal; and
an acquiring unit configured to acquire the information from the mobile terminal in response to the request by the requesting unit.

8. A non-transitory computer-readable medium that contains a computer program that, when executed by a computer of an image forming apparatus connected to a mobile terminal via a wireless network, cause the computer to perform operations comprising:
performing authentication of the mobile terminal using user authentication information and identification information of the mobile terminal that are registered in advance to the image forming apparatus;
requesting to acquire information stored in the mobile terminal; and
acquiring the information from the mobile terminal in response to the requesting.
